(19) United States
(12) Patent Application Publication
(10) Pub. No.: US 2018/0173620 A1
(43) Pub. Date: Jun. 21, 2018

(54) DATA ERASURE METHOD FOR SOLID STATE DRIVE, AND APPARATUS

(71) Applicant: HUAWEI TECHNOLOGIES CO., LTD., Shenzhen (CN)

(72) Inventors: Xinxing CEN, Shenzhen (CN); Zhen ZENG, Shenzhen (CN)

(73) Assignee: HUAWEI TECHNOLOGIES CO., LTD., Shenzhen (CN)

(21) Appl. No.: 15/896,972

(22) Filed: Feb. 14, 2018

Related U.S. Application Data
(63) Continuation of application No. PCT/CN2016/093582, filed on Aug. 5, 2016.

(30) Foreign Application Priority Data
Sep. 23, 2015 (CN) 201510611537.6

(51) Int. Cl. G06F 12/02; G06F 3/06

(52) U.S. Cl. CPC G06F 12/0246; G06F 3/0652; G06F 2212/7205; G06F 3/0604; G06F 3/0679; G06F 3/064

(57) ABSTRACT

A data erasure solution for a solid state drive is provided. The solid state drive includes a first target storage area and a second target storage area, each of the first target storage area and the second target storage area includes an idle block and an occupied block. The first target storage area stores only data of a first target application. The second target storage area stores only data of a second target application. The solid state drive can perform data erasure operation on target storage areas independently according to idle state of applications.

### CROSS-REFERENCE TO RELATED APPLICATIONS

This application is a continuation of International Application No. PCT/CN2016/093582, filed on Aug. 5, 2016, which claims priority to Chinese Application No. 201510611537.6, filed on Sep. 23, 2015. The disclosures of the aforementioned applications are hereby incorporated by reference in their entireties.

### TECHNICAL FIELD

The present disclosure relates to the computer field, and in particular, to a data erasure method for a solid state drive, and an apparatus.

### BACKGROUND

A solid state drive (SSD) develops rapidly over recent years. Due to advantages of the solid state drive, such as a high access speed and high shock resistance, the solid state drive is applied more widely.

The solid state drive is a flash memory-based data storage device, a minimum erasure unit of the solid state drive is a block, one block includes a plurality of pages, and a page is a minimum read/write unit of the solid state drive. A quantity of allowed erasure times of a block is limited. Therefore, when writing data of applications into blocks, a storage controller of the solid state drive evenly allocates the data to the blocks usually by using a wear leveling algorithm. In this way, data of a plurality of applications may be stored in a same block at the same time.

Before performing data erasure on a block, a storage controller needs to migrate valid data stored in the block to another idle block for storage. Data of a plurality of applications may be stored in a same block, and states of the applications are different, for example, one application is in an idle state, and another application is in a working state. Therefore, in the prior art, when the storage controller performs data erasure on a block, normal operation of a plurality of applications may be affected.

### SUMMARY

The present disclosure provides a data erasure method for a solid state drive, and an apparatus, so as to resolve a prior-art problem of impact on operating performance of an application during data erasure.

To achieve the foregoing objective, the following technical solutions are used in the present disclosure.

According to a first aspect, a data erasure method for a solid state drive is provided. The solid state drive comprises a storage controller and a storage medium, the storage medium comprises a first target storage area, the first target storage area comprises an idle block and an occupied block, the first target storage area stores only data of a first target application. The method may include: determining, by the storage controller, an occupied block that requires a data erasure operation from the first target storage area when the first target application is in an idle state; reading, by the storage controller, valid data from the occupied block that requires the data erasure operation from the first target storage area; writing, by the storage controller, the valid data into the idle block in the first target storage area; and erasing, by the storage controller, data in the occupied block that requires the data erasure operation from the first target storage area.

According to a second aspect, a solid state drive includes a storage controller and a storage medium. The storage medium comprises a first target storage area, the first target storage area comprises an idle block and an occupied block, the first target storage area stores only data of a first target application. The storage controller is configured to: determine an occupied block that requires a data erasure operation from the first target storage area when the first target application is in an idle state; read valid data from the occupied block that requires the data erasure operation from the first target storage area; write the valid data into the idle block in the first target storage area; and erase data in the occupied block that requires the data erasure operation from the first target storage area.

According to a third aspect, a non-transitory computer readable storage medium is provided. The non-transitory computer readable storage medium stores instructions that when executed by a storage controller in a solid state drive, cause the storage controller to: determine an occupied block that requires a data erasure operation from a first target storage area in the solid state drive when a first target application is in an idle state; wherein the first target storage area stores only data of the first target application; read valid data from the occupied block that requires a data erasure operation from the first target storage area; write the valid data into an idle block in the first target storage area; and erase data in the occupied block that requires a data erasure operation from the first target storage area.

### BRIEF DESCRIPTION OF DRAWINGS

To describe the technical solutions in the embodiments of the present disclosure more clearly, the following briefly describes the accompanying drawings required for describing the embodiments.

FIG. 1 is a schematic structural diagram of a solid state drive according to an aspect of the present disclosure;

FIG. 2 is a schematic flowchart of a data erasure method for a solid state drive according to an aspect of the present disclosure;

FIG. 3 is a schematic diagram of a target storage area in a storage medium according to an aspect of the present disclosure;

FIG. 4 is a schematic flowchart of another data erasure method for a solid state drive according to an aspect of the present disclosure;

FIG. 5 is a schematic structural diagram of a data storage system according to an aspect of the present disclosure;

FIG. 6 is a schematic flowchart of still another data erasure method for a solid state drive according to an aspect of the present disclosure;

FIG. 7 is a schematic structural diagram of another solid state drive according to an aspect of the present disclosure;

FIG. 8 is a schematic structural diagram of still another solid state drive according to an aspect of the present disclosure;

FIG. 9 is a schematic structural diagram of an application server according to an aspect of the present disclosure; and

FIG. 10 is a schematic structural diagram of another application server according to an aspect of the present disclosure.

### DESCRIPTION OF EMBODIMENTS

To make persons skilled in the art understand the technical solutions provided in the present disclosure more easily, a data write process of a solid state drive is first simply described.

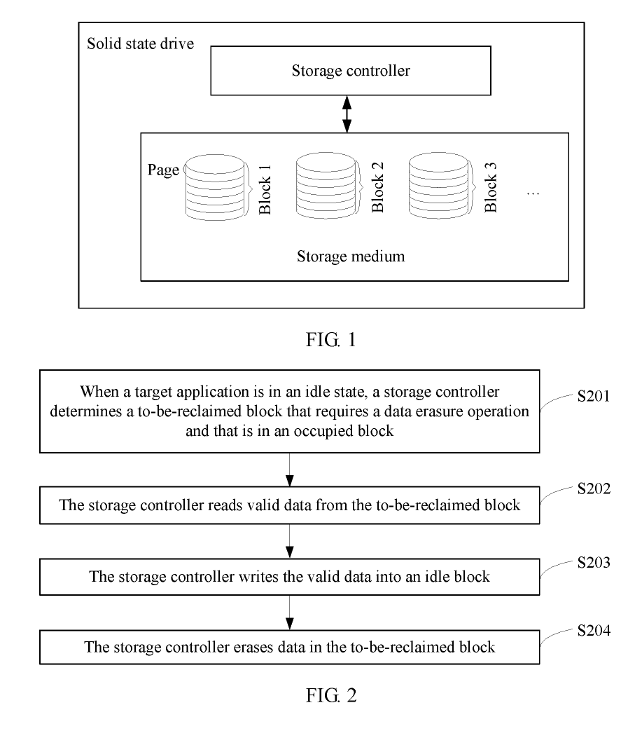

As shown in FIG. 1, a solid state drive includes a storage controller and a storage medium connected to the storage controller. The storage medium includes a plurality of blocks such as a block 1, a block 2, and a block 3. Each block includes a plurality of pages, a minimum read/write unit of the storage medium is a page, and data can be written into the page only when the page is idle. That is, if the page includes data, when updating data in the page, the storage controller cannot directly overwrite the data, but needs to erase the data in the page first, and then can write new data into the page. However, the solid state drive needs to perform data erasure at a granularity of a block.

In order to increase a write speed of a storage medium of a solid state drive, when updating data in any page, a storage controller writes to-be-updated data into an idle page, and after updating a logical block addressing correspondence, marks the page as invalid. The logical block addressing correspondence is a correspondence that is recorded at a flash translation layer (FTL) of the storage controller and that is between a logical block address (LBA) and a physical block address (PBA). The FTL is used to translate a logical block address in a data read instruction and a data write instruction that are received by the storage controller into a physical block address, so that the storage controller performs a data read/write operation on the storage medium of the solid state drive according to the physical block address.

It may be learned from the foregoing that, in a data write process, invalid pages in the storage medium of the solid state drive are increasing, and accordingly, idle blocks in the storage medium are decreasing. In the prior art, a threshold is set for a quantity of idle blocks included in the storage medium of the solid state drive, and when detecting that a quantity of remaining idle blocks is less than the threshold, the storage controller starts data erasure on the block.

The embodiments of the present disclosure provide a data erasure method for a solid state drive and a storage controller, so as to resolve a prior-art problem of impact on operating performance of an application during data erasure. To make the objectives, technical solutions, and advantages of the embodiments of the present disclosure clearer, the following describes the technical solutions in the embodiments of the present disclosure clearly with reference to the accompanying drawings in the embodiments of the present disclosure.

This present disclosure provides a data erasure method for a solid state drive. The solid state drive includes a storage controller and a storage medium, the storage medium includes a target storage area, the target storage area includes an idle block and an occupied block, and the occupied block stores only data of a target application. As shown in FIG. 2, the method includes:

S201. When the target application is in an idle state, the storage controller determines a to-be-reclaimed block that requires a data erasure operation and that is in the occupied block.

S202. The storage controller reads valid data from the to-be-reclaimed block.

S203. The storage controller writes the valid data into the idle block.

S204. The storage controller erases data in the to-be-reclaimed block.

According to step S201 to step S204, the occupied block included in the target storage area stores only data of the target application. Therefore, when the storage controller performs data erasure on the to-be-reclaimed block that requires a data erasure operation and that is in the occupied block, another application is not affected. Moreover, when the storage controller performs data erasure on the to-be-reclaimed block, the target application is in the idle state. Therefore, operating performance of the target application is not affected either. Therefore, it may be learned that, according to the data erasure method for a solid state drive provided in the present disclosure, a prior-art problem of impact on operating performance of an application during data erasure can be resolved.

The following describes step S201 to step S204 in detail by using specific examples.

It may be learned from the foregoing description that the storage medium of the solid state drive includes the target storage area, the target storage area includes the idle block and the occupied block, and the occupied block stores only data of the target application. That is, for each application running on an application server, the storage medium of the solid state drive may include a target storage area, and a block in the target storage area is used to store only data of a corresponding target application. The following describes a specific implementation by using an example.

For example, the storage controller receives a request message sent by the application server, and the request message is used to request the storage controller to allocate, in the storage medium of the solid state drive, the target storage area to the target application. Further, the storage controller may establish and store a correspondence between the target application and the target storage area. In this way, after receiving a data write instruction used to write data of the target application, the storage controller writes data of the target application into the block in the target storage area.

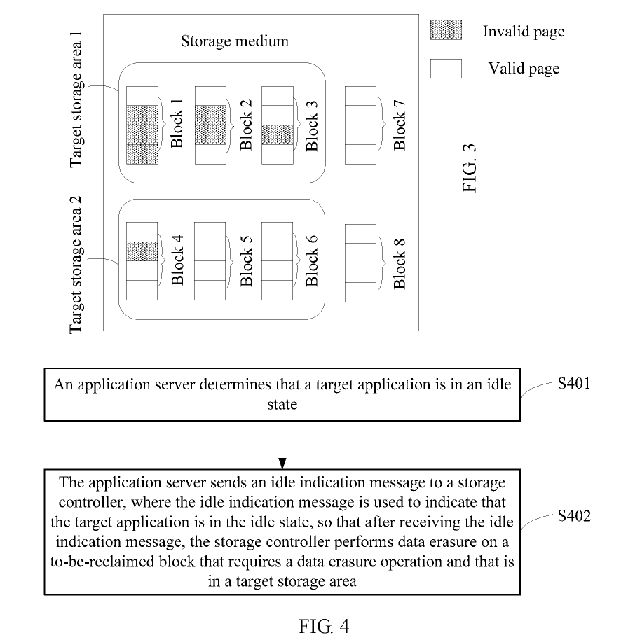

As shown in FIG. 3, the storage controller allocates a block 1, a block 2, and a block 3 in the storage medium of the solid state drive as a target storage area 1 to an application 1 for data storage, and allocates a block 4, a block 5, and a block 6 as a target storage area 2 to an application 2 for data storage, according to the request message sent by the application server. In this way, after receiving data, sent by the application server, of the application 1, the storage controller writes the data of the application 1 into a block in the target storage area 1, and after receiving data, sent by the application server, of the application 2, writes the data of the application 2 into a block in the target storage area 2, thereby ensuring that the occupied block in the target storage area stores only data of the target application, and further ensuring that another application is not affected when erasure is performed on the block.

The foregoing is described only as an example. As shown in FIG. 3, a quantity of blocks included in the target storage area 1 is the same as a quantity of blocks included in the target storage area 2. However, in a specific implementation process, for different applications, a user may preset a quantity of blocks occupied by each application. In this way, the storage controller may allocate, according to the quantity of blocks that is preset by the user, a target storage area corresponding to each application. This is not limited in the present disclosure.

In addition, it should be noted that data read/write amounts and data read/write frequencies of different applications may be different. Therefore, data erasure frequencies of blocks in different target storage areas may be different. In order to avoid an excessively large wear difference between blocks located in different target storage areas, in this embodiment of the present disclosure, a block included in the target storage area may change dynamically. Specifically, the storage controller may replace the block in the target storage area with an unallocated idle block in the storage medium. For example, as shown in FIG. 3, for unallocated blocks 7 and 8 in the storage medium, the storage controller may replace the block 1 in the target storage area 1 with the block 7, and in this case, the block 4 in the target storage area 2 may be replaced with the unallocated block 8. Therefore, wear degrees of the blocks are relatively balanced.

Specifically, in a possible implementation of step S201, the storage controller receives an idle indication message sent by the application server. The application server runs the target application, and the idle indication message is used to indicate that the target application is in the idle state. In this way, after determining, according to the idle indication message, that the target application is in the idle state, the storage controller determines the to-be-reclaimed block that requires a data erasure operation and that is in the occupied block.

For example, a plurality of applications run on the application server, and the application server may detect, by using a quality of service (QoS) technology, whether the applications are in the idle state. In this way, after detecting that the target application is in the idle state, the application server sends the idle indication message to the storage controller.

Further, in a possible implementation of this embodiment of the present disclosure, the determining, by the storage controller, a to-be-reclaimed block that requires an erasure operation and that is in the occupied block in step S201 specifically includes: determining that a block that includes a quantity of invalid pages greater than a second threshold and that is in the occupied block in the target storage area is the to-be-reclaimed block that requires a data erasure operation.

The second threshold may be set according to a specific requirement. As shown in FIG. 3, the target storage area 1 includes the blocks 1 to 3. When the second threshold is 1, the block 1 and the block 2 are to-be-reclaimed blocks that require an erasure operation.

The foregoing is described only as an example. In this embodiment of the present disclosure, alternatively, quantities of invalid pages included in the blocks in the target storage area may be compared, to determine that a block including a largest quantity of invalid pages is the to-be-reclaimed block. This is not limited in the present disclosure.

It should be noted that, in a specific implementation process, when the target application is in the idle state, the target storage area may include sufficient idle storage space, and data erasure does not need to be performed. For example, for the target storage area 2 shown in FIG. 3, only the block 4 in the target storage area 2 includes an invalid page. In this case, when the storage controller performs data erasure on the block 4, frequent erasure may accelerate block wear. Therefore, in a implementation of this embodiment of the present disclosure, before determining the to-be-reclaimed block, the storage controller may first determine that a quantity of idle blocks in the target storage area is less than a first threshold.

For example, the first threshold may be preset. The storage controller records a first threshold that is for an idle block and that is corresponding to each target storage area in the storage medium. As shown in FIG. 3, when a first threshold that is for an idle block and that is preset for the target storage area 1 is 1, and in this case, when the application 1 is in the idle state, the storage controller may determine a to-be-reclaimed block in the target storage area 1 after detecting that a quantity of idle blocks in the target storage area 1 is less than the first threshold.

It should be noted that a process of the foregoing detailed description of step S201 to step S204 is related to a combination of other optional steps. Persons skilled in the art should understand that the present disclosure is not limited by the described sequence of the steps. For example, in a specific implementation process of this embodiment of the present disclosure, the storage controller may first receive the idle indication message sent by the application server, and then determine the to-be-reclaimed block in the target storage area after determining, according to the idle indication message, that the target application is in the idle state. In addition, the storage controller may alternatively send a query message to the application server after determining that the quantity of idle blocks in the target storage area is less than the first threshold, and then determine the to-be-reclaimed block in the target storage area after determining, according to the idle indication message returned by the application server, that the target application is in the idle state.

This present disclosure provides another data erasure method for a solid state drive. The method is applied to an application server, the application server is connected to a solid state drive, the application server runs a target application, the solid state drive includes a storage controller and a storage medium, the storage medium includes a target storage area, the target storage area includes an idle block and an occupied block, and the occupied block stores only data of the target application. As shown in FIG. 4, the method includes:

S401. The application server determines that the target application is in an idle state.

S402. The application server sends an idle indication message to the storage controller, where the idle indication message is used to indicate that the target application is in the idle state, so that after receiving the idle indication message, the storage controller performs data erasure on a to-be-reclaimed block that requires a data erasure operation and that is in the target storage area.

According to step S401 and step S402, the application server sends the idle indication message to the storage controller, so that after determining that the target application is in the idle state, the storage controller can perform data erasure on the to-be-reclaimed block that stores only data of the target application, thereby avoiding adverse impact, caused in a process of performing data erasure by the storage controller, on operating performance of the target application.

The following describes step S401 and step S402 in detail.

In a possible implementation of step S401, the application server detects a quantity of remaining tokens in a token bucket corresponding to the target application; and determines that the target application is in the idle state when the quantity of remaining tokens is greater than or equal to a token threshold.

It should be noted that tokens are added to the token bucket at a specific rate, and an application is allowed to perform one operation on each token. For example, each time the application sends a data packet, a quantity, corresponding to a size of the data packet, of tokens are deleted from a token bucket. In this case, a larger quantity of tokens in the token bucket indicates a smaller quantity of data packets sent by the application. Therefore, in this embodiment of the present disclosure, a threshold for tokens in a token bucket corresponding to each application may be preset, and the token threshold may be equal to a largest quantity of tokens included in the token bucket. In this way, when the application server detects that a quantity of tokens in a token bucket corresponding to a first application is equal to a largest quantity of tokens included in the token bucket, it indicates that the first application has not sent a data packet, and is in the idle state. The token threshold may be specifically set according to actual application. This is not limited in the present disclosure.

Alternatively or additionally, before the determining, by the application server, that the target application is in an idle state, the method further includes:

sending, by the application server, a request message to the storage controller, where the request message is used to request the storage controller to allocate, in the storage medium of the solid state drive, the target storage area to the target application.

With reference to the content of the description in Embodiment 1, for example, after receiving the request message sent by the application server, the storage controller allocates the target storage area to the target application. Further, the storage controller may establish and store a correspondence between the target application and the target storage area. In this way, after receiving a data write instruction used to write data of the target application, the storage controller always writes data of the target application into a block in the corresponding target storage area, thereby ensuring that the occupied block in the target storage area stores only data of the target application, and ensuring that another application is not affected when erasure is performed on the block.

Further, in a possible implementation of this embodiment of the present disclosure, for a specific process of performing data erasure on the to-be-reclaimed block in the target storage area by the storage controller, refer to the content in Embodiment 1. Details are not described herein again. With reference to the content in Embodiment 1, the occupied block included in the target storage area stores only data of the target application. Therefore, when the storage controller performs data erasure on the to-be-reclaimed block that requires a data erasure operation and that is in the occupied block, another application is not affected. Moreover, when the storage controller performs data erasure on the to-be-reclaimed block, the target application is in the idle state. Therefore, operating performance of the target application is not affected either.

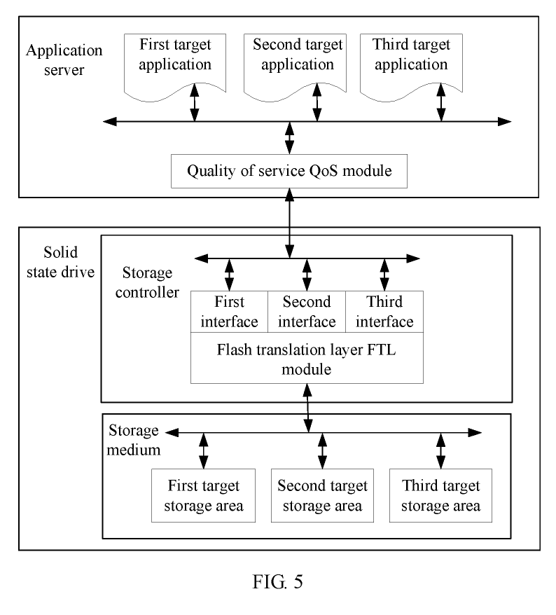

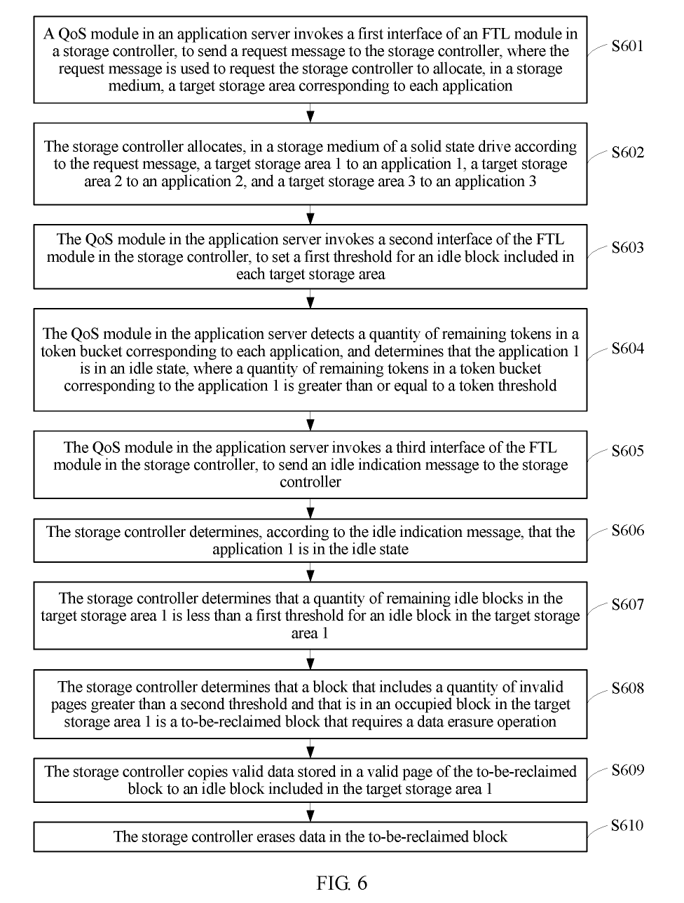

To make persons skilled in the art understand the technical solutions of the data erasure method for a solid state drive provided in the present disclosure more clearly, the following describes a data erasure method for a solid state drive provided in this embodiment of the present disclosure with reference to a data storage system shown in FIG. 5. As shown in FIG. 5, the data storage system includes an application server and a solid state drive connected to the application server. The application server includes a quality of service (QoS) module, and runs a first target application, a second target application, and a third target application. The QoS module may be specifically a program, a processor, or an integrated circuit that is used to implement a QoS algorithm. The solid state drive includes a storage controller and a storage medium, and the storage controller includes a flash translation layer FTL module. The FTL module may be specifically a program, a processor, or an integrated circuit, can translate a logical block address into a physical block address, and provides a first interface, a second interface, and a third interface for the QoS module for invoking. The storage medium includes a first target storage area, a second target storage area, and a third target storage area, which respectively saves data of the first target application, the second target application, and the third target application. Based on the data storage system shown in FIG. 5, the data erasure method for a solid state drive provided in this embodiment of the present disclosure is shown in FIG. 6, and includes the following steps.

S601. The QoS module in the application server invokes the first interface of the FTL module in the storage controller, to send a request message to the storage controller, where the request message is used to request the storage controller to allocate, in the storage medium, a target storage area corresponding to each application.

S602. The storage controller allocates, in the storage medium of the solid state drive according to the request message, the target storage area 1 to the application 1, the target storage area 2 to the application 2, and the target storage area 3 to the application 3.

It should be noted that, after the storage controller allocates the target storage areas to the applications, the storage controller always stores data of the application 1 into a block in the target storage area 1, always stores data of the application 2 into a block in the target storage area 2, and always stores data of the application 3 into a block in the target storage area 3.

S603. The QoS module in the application server invokes the second interface of the FTL module in the storage controller, to set a first threshold for an idle block included in each target storage area.

S604. The QoS module in the application server detects a quantity of remaining tokens in a token bucket corresponding to each application, and determines that the application 1 is in an idle state, where a quantity of remaining tokens in a token bucket corresponding to the application 1 is greater than or equal to a token threshold.

S605. The QoS module in the application server invokes the third interface of the FTL module in the storage controller, to send an idle indication message to the storage controller.

S606. The storage controller determines, according to the idle indication message, that the application 1 is in the idle state.

S607. The storage controller determines that a quantity of remaining idle blocks in the target storage area 1 is less than a first threshold for an idle block in the target storage area 1.

S608. The storage controller determines that a block that includes a quantity of invalid pages greater than a second threshold and that is in an occupied block in the target storage area 1 is a to-be-reclaimed block that requires a data erasure operation.

It should be noted that a file system in the application server may send a Trim instruction to the FTL module in the storage controller, and the FTL module marks, according to the Trim instruction, an invalid page in an occupied block included in the storage medium. In this way, when determining a to-be-reclaimed block that requires an erasure operation, the storage controller may alternatively compare quantities of invalid pages included in occupied blocks in the target storage area 1, to determine that an occupied block including a largest quantity of invalid pages is the to-be-reclaimed block.

S609. The storage controller copies valid data stored in a valid page of the to-be-reclaimed block to an idle block included in the target storage area 1.

S610. The storage controller erases data in the to-be-reclaimed block.

Further, after erasing the data in the to-be-reclaimed block, the storage controller may mark an invalid page in the to-be-reclaimed block as valid, so that the storage controller can subsequently write new data into the to-be-reclaimed block.

In this way, according to step S601 to step S610, the occupied block in the target storage area 1 stores only data of the application 1. Therefore, when the storage controller copies the valid data stored in the to-be-reclaimed block in the target storage area 1 to the idle block, other applications 2 and 3 are not affected. Moreover, before performing data erasure on the to-be-reclaimed block, the storage controller has determined that the application 1 is in the idle state. Therefore, when the storage controller performs data erasure on the to-be-reclaimed block, operating performance of the application 1 is not affected either.

It should be noted that, for ease of description, the foregoing method embodiments are described as a series of action combinations. However, persons skilled in the art should understand that the present disclosure is not limited by the described action sequence.

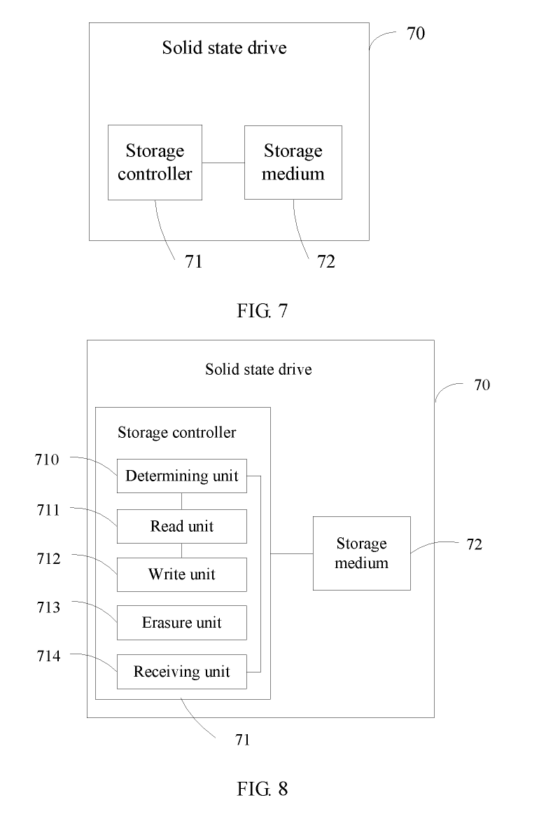

This present disclosure provides a solid state drive 70. As shown in FIG. 7, the solid state drive 70 includes a storage controller 71 and a storage medium 72 connected to the storage controller 71.

The storage medium 72 includes a target storage area, the target storage area includes an idle block and an occupied block, and the occupied block stores only data of a target application.

The storage controller 71 is configured to execute the data erasure method for a solid state drive provided in Embodiment 1. For details, refer to corresponding content in Embodiment 1. Details are not described herein again.

According to the foregoing solid state drive, the occupied block included in the target storage area in the storage medium of the solid state drive stores only data of the target application. Therefore, when the storage controller of the solid state drive performs data erasure on a to-be-reclaimed block that requires a data erasure operation and that is in the occupied block, another application is not affected. Moreover, when the storage controller performs data erasure on the to-be-reclaimed block, the target application is in an idle state. Therefore, operating performance of the target application is not affected either.

In a possible implementation of this embodiment of the present disclosure, as shown in FIG. 8, the storage controller 71 includes:

a determining unit 710, configured to: when the target application is in the idle state, determine a to-be-reclaimed block that requires a data erasure operation and that is in the occupied block;

a read unit 711, configured to read valid data from the to-be-reclaimed block;

a write unit 712, configured to write the valid data into the idle block; and

an erasure unit 713, configured to erase data in the to-be-reclaimed block.

Alternatively or additionally, as shown in FIG. 8, the storage controller 71 further includes:

a receiving unit 714, configured to receive an idle indication message sent by an application server, where the application server runs the target application, and the idle indication message is used to indicate that the target application is in the idle state.

For example, a plurality of applications run on the application server, and the application server may detect, by using a quality of service QoS technology, whether the applications are in the idle state. In this way, after detecting that the target application is in the idle state, the application server sends the idle indication message to the storage controller.

In addition, it may be learned from the foregoing description that the storage medium of the solid state drive includes the target storage area, the target storage area includes the idle block and the occupied block, and the occupied block stores only data of the target application. That is, for each application running on the application server, the storage medium of the solid state drive may include a target storage area, and a block in the target storage area is used to store only data of a corresponding target application. The following describes a specific implementation by using an example.

Alternatively or additionally, the receiving unit 714 is further configured to receive a request message sent by the application server. The request message is used to request the storage controller to allocate, in the storage medium of the solid state drive, the target storage area to the target application. Further, the storage controller may establish and store a correspondence between the target application and the target storage area. In this way, after receiving a data write instruction used to write data of the target application, the storage controller always writes data of the target application into a block in the corresponding target storage area.

Alternatively or additionally, the determining unit 710 is further configured to determine that a quantity of idle blocks in the target storage area is less than a first threshold.

Alternatively or additionally, the determining unit 710 is specifically configured to determine that a block that includes a quantity of invalid pages greater than a second threshold and that is in the occupied block in the target storage area is the to-be-reclaimed block that requires a data erasure operation.

It should be noted that persons skilled in the art may clearly understand that, for ease and brevity of description, for a specific working process and description of the storage controller, refer to a corresponding process in the foregoing method embodiments. Details are not described herein again.

In addition, the foregoing unit division for the storage controller is merely logical function division and may be in another division manner in actual implementation, and a specific physical implementation of each unit is not limited in the present disclosure. For example, in a specific implementation process, the receiving unit 714 shown in FIG. 8 may be a transceiver, the determining unit 710 may be a logical determining circuit, and the read unit 711 and the write unit 712 may be a processor executing a data read/write thread, or the like.

This present disclosure provides an application server 90. The application server 90 is connected to a solid state drive, the application server 90 runs a target application, the solid state drive includes a storage controller and a storage medium, the storage medium includes a target storage area, the target storage area includes an idle block and an occupied block, and the occupied block stores only data of the target application. The application server 90 provided here is configured to implement the data erasure method for a solid state drive provided above. As shown in FIG. 9, the application server 90 includes:

a determining unit 91, configured to determine that the target application is in an idle state; and a sending unit 92, configured to send an idle indication message to the storage controller, where the idle indication message is used to indicate that the target application is in the idle state, so that after receiving the idle indication message, the storage controller performs data erasure on a to-be-reclaimed block that requires a data erasure operation and that is in the target storage area.

Alternatively or additionally, the determining unit 91 is specifically configured to: detect a quantity of remaining tokens in a token bucket corresponding to the target application; and when the quantity of remaining tokens is greater than or equal to a token threshold, determine that the target application is in the idle state.

It should be noted that tokens are added to the token bucket at a specific rate, and an application is allowed to perform one operation on each token. For example, each time the application sends a data packet, a quantity, corresponding to a size of the data packet, of tokens are deleted from a token bucket. In this case, a larger quantity of tokens in the token bucket indicates a smaller quantity of data packets sent by the application. Therefore, in this embodiment of the present disclosure, a threshold for tokens in a token bucket corresponding to each application may be preset, and the token threshold may be equal to a largest quantity of tokens included in the token bucket. In this way, when the application server detects that a quantity of tokens in a token bucket corresponding to a first application is equal to a largest quantity of tokens included in the token bucket, it indicates that the first application has not sent a data packet, and is in the idle state. The token threshold may be specifically set according to actual application. This is not limited in the present disclosure.

Alternatively or additionally, the sending unit 92 is further configured to send a request message to the storage controller, where the request message is used to request the storage controller to allocate, in the storage medium, the target storage area to the target application.

For example, after receiving the request message sent by the application server, the storage controller allocates the target storage area to the target application. Further, the storage controller may establish and store a correspondence between the target application and the target storage area. In this way, after receiving a data write instruction used to write data of the target application, the storage controller always writes data of the target application into a block in the corresponding target storage area, thereby ensuring that the occupied block in the target storage area stores only data of the target application, and ensuring that another application is not affected when erasure is performed on the block.

Persons skilled in the art may clearly understand that, for ease and brevity of description, for a specific working process and description of the storage controller, refer to a corresponding process in the foregoing method embodiments. Details are not described herein again.

According to the application server, the application server sends the idle indication message to the storage controller, so that after determining that the target application is in the idle state, the storage controller can perform data erasure on the to-be-reclaimed block that stores only data of the target application, thereby avoiding adverse impact, caused in a process of performing data erasure by the storage controller, on operating performance of the target application.

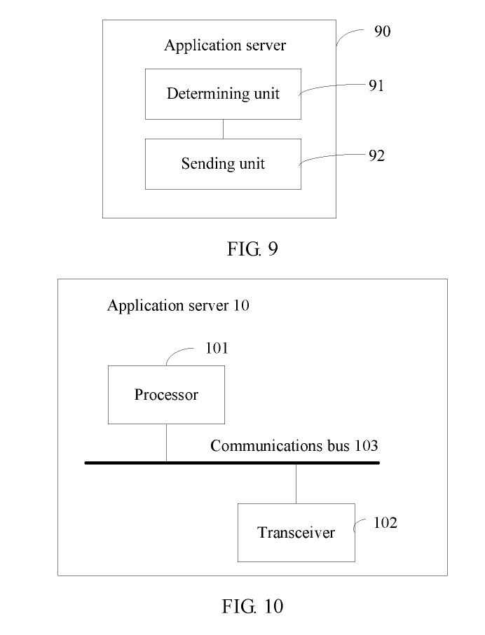

This disclosure provides another application server 10. As shown in FIG. 10, the application server 10 includes:

a processor 101, a transceiver 102, and a communications bus 103, where the processor 101 and the transceiver 102 communicate with each other by using the communications bus 103.

The processor 101 may be a multi-core central processing unit CPU, or an application-specific integrated circuit (ASIC), or one or more integrated circuits configured to implement this embodiment of the present disclosure.

Specifically, the application server 10 is connected to a solid state drive, the transceiver 102 is configured to implement connection and communication between the application server 10 and the solid state drive, the application server 10 runs a target application, the solid state drive includes a storage controller and a storage medium, the storage medium includes a target storage area, the target storage area includes an idle block and an occupied block, and the occupied block stores only data of the target application. The processor 101 is configured to implement the following operations:

determining that the target application is in an idle state; and

sending an idle indication message to the storage controller, where the idle indication message is used to indicate that the target application is in the idle state, so that after receiving the idle indication message, the storage controller performs data erasure on a to-be-reclaimed block that requires a data erasure operation and that is in the target storage area.

Alternatively or additionally, the determining that the target application is in an idle state specifically includes:

detecting a quantity of remaining tokens in a token bucket corresponding to the target application; and

determining that the target application is in the idle state when the quantity of remaining tokens is greater than or equal to a token threshold.

Alternatively or additionally, the operations further include:

sending a request message to the storage controller, where the request message is used to request the storage controller to allocate, in the storage medium, the target storage area to the target application.

According to a first aspect, a data erasure method for a solid state drive is provided. The solid state drive includes a storage controller and a storage medium, the storage medium includes a target storage area, the target storage area includes an idle block and an occupied block, the occupied block stores only data of a target application. The method includes:

when the target application is in an idle state, determining, by the storage controller, a to-be-reclaimed block that requires a data erasure operation and that is in the occupied block;

reading, by the storage controller, valid data from the to-be-reclaimed block;

writing, by the storage controller, the valid data into the idle block; and

erasing, by the storage controller, data in the to-be-reclaimed block.

With reference to the first aspect, in a first possible implementation of the first aspect, the method further includes:

receiving, by the storage controller, an idle indication message sent by an application server, where the application server runs the target application, and the idle indication message is used to indicate that the target application is in the idle state.

With reference to the first aspect or the first possible implementation of the first aspect, in a second possible implementation of the first aspect, before the determining, by the storage controller, a to-be-reclaimed block that requires a data erasure operation and that is in the occupied block, the method further includes:

determining, by the storage controller, that a quantity of idle blocks in the target storage area is less than a first threshold.

With reference to any one of the first aspect or the first to the second possible implementations of the first aspect, in a third possible implementation of the first aspect, the determining, by the storage controller, a to-be-reclaimed block that requires a data erasure operation and that is in the occupied block includes:

determining that a block that includes a quantity of invalid pages greater than a second threshold and that is in the occupied block in the target storage area is the to-be-reclaimed block that requires a data erasure operation.

According to a second aspect, another data erasure method for a solid state drive is provided. The method is applied to an application server, the application server is connected to a solid state drive, the application server runs a target application, the solid state drive includes a storage controller and a storage medium, the storage medium includes a target storage area, the target storage area includes an idle block and an occupied block, and the occupied block stores only data of the target application. The method includes:

determining, by the application server, that the target application is in an idle state; and

sending, by the application server, an idle indication message to the storage controller, where the idle indication message is used to indicate that the target application is in the idle state, so that after receiving the idle indication message, the storage controller performs data erasure on a to-be-reclaimed block that requires a data erasure operation and that is in the target storage area.

With reference to the second aspect, in a first possible implementation of the second aspect, the determining, by the application server, that the target application is in an idle state includes:

detecting, by the application server, a quantity of remaining tokens in a token bucket corresponding to the target application; and

determining that the target application is in the idle state when the quantity of remaining tokens is greater than or equal to a token threshold.

With reference to the second aspect or the first possible implementation of the second aspect, in a second possible implementation of the second aspect, before the determining, by the application server, that the target application is in an idle state, the method further includes:

sending, by the application server, a request message to the storage controller, where the request message is used to request the storage controller to allocate, in the storage medium, the target storage area to the target application.

According to a third aspect, a solid state drive is provided. The solid state drive includes a storage controller and a storage medium, the storage medium includes a target storage area, the target storage area includes an idle block and an occupied block, the occupied block stores only data of a target application. The storage controller includes:

a determining unit, configured to: when the target application is in an idle state, determine a to-be-reclaimed block that requires a data erasure operation and that is in the occupied block;

a read unit, configured to read valid data from the to-be-reclaimed block;

a write unit, configured to write the valid data into the idle block; and

an erasure unit, configured to erase data in the to-be-reclaimed block.

With reference to the third aspect, in a first possible implementation of the third aspect, the solid state drive further includes:

a receiving unit, configured to receive an idle indication message sent by an application server, where the application server runs the target application, and the idle indication message is used to indicate that the target application is in the idle state.

With reference to the third aspect or the first possible implementation of the third aspect, in a second possible implementation of the third aspect, the determining unit is further configured to determine that a quantity of idle blocks in the target storage area is less than a first threshold.

With reference to any one of the third aspect or the first to the second possible implementations of the third aspect, in a third possible implementation of the third aspect, the determining unit is specifically configured to determine that a block that includes a quantity of invalid pages greater than a second threshold and that is in the occupied block in the target storage area is the to-be-reclaimed block that requires a data erasure operation.

According to a fourth aspect, a solid state drive is provided. The solid state drive includes a storage controller and a storage medium connected to the storage controller, the storage medium includes a target storage area, the target storage area includes an idle block and an occupied block, and the occupied block stores only data of a target application; and

the storage controller is configured to execute the method according to any one of the first aspect or the first to the third possible implementations of the first aspect.

According to a fifth aspect, an application server is provided. The application server is connected to a solid state drive, the application server runs a target application, the solid state drive includes a storage controller and a storage medium, the storage medium includes a target storage area, the target storage area includes an idle block and an occupied block, and the occupied block stores only data of the target application. The application server includes:

a determining unit, configured to determine that the target application is in an idle state; and

a sending unit, configured to send an idle indication message to the storage controller, where the idle indication message is used to indicate that the target application is in the idle state, so that after receiving the idle indication message, the storage controller performs data erasure on a to-be-reclaimed block that requires a data erasure operation and that is in the target storage area.

With reference to the fifth aspect, in a first possible implementation of the fifth aspect, the determining unit is specifically configured to: detect a quantity of remaining tokens in a token bucket corresponding to the target application; and when the quantity of remaining tokens is greater than or equal to a token threshold, determine that the target application is in the idle state.

With reference to the fifth aspect or the first possible implementation of the fifth aspect, in a second possible implementation of the fifth aspect, the sending unit is further configured to send a request message to the storage controller, where the request message is used to request the storage controller to allocate, in the storage medium, the target storage area to the target application.

According to a sixth aspect, an application server is provided. The application server is connected to a solid state drive, the application server runs a target application, the solid state drive includes a storage controller and a storage medium, the storage medium includes a target storage area, the target storage area includes an idle block and an occupied block, and the occupied block stores only data of the target application; and the application server includes a processor, a transceiver, and a communications bus, where the processor and the transceiver communicate with each other by using the communications bus. The processor is configured to: determine that the target application is in an idle state; and send an idle indication message to the storage controller, where the idle indication message is used to indicate that the target application is in the idle state, so that after receiving the idle indication message, the storage controller performs data erasure on a to-be-reclaimed block that requires a data erasure operation and that is in the target storage area.

With reference to the sixth aspect, in the first possible implementation of the sixth aspect, the processor is specifically configured to:

detect a quantity of remaining tokens in a token bucket corresponding to the target application; and

determine that the target application is in the idle state when the quantity of remaining tokens is greater than or equal to a token threshold.

With reference to the sixth aspect or the first possible implementation of the sixth aspect, in a second possible implementation of the sixth aspect, the processor is further configured to:

send a request message to the storage controller, where the request message is used to request the storage controller to allocate, in the storage medium, the target storage area to the target application.

According to the foregoing solutions, the occupied block included in the target storage area stores only data of the target application. Therefore, when the storage controller performs data erasure on the to-be-reclaimed block that requires a data erasure operation and that is in the occupied block, another application is not affected. Moreover, when the storage controller performs data erasure on the to-be-reclaimed block, the target application is in the idle state. Therefore, operating performance of the target application is not affected either. Therefore, it may be learned that, according to the data erasure method for a solid state drive provided in the present disclosure, a prior-art problem of impact on operating performance of an application during data erasure can be resolved.

In the embodiments provided in this application, it should be understood that the disclosed system, apparatus, and method may be implemented in other manners. For example, the described apparatus embodiment is merely an example. For example, the unit division is merely logical function division and may be in another division manner in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

What is claimed is:

1. A data erasure method for a solid state drive, wherein the solid state drive comprises a storage controller and a storage medium, the storage medium comprises a first target storage area, the first target storage area comprises an idle block and an occupied block, the first target storage area stores only data of a first target application, and the method comprises:
determining, by the storage controller, an occupied block that requires a data erasure operation from the first target storage area when the first target application is in an idle state;
reading, by the storage controller, valid data from the occupied block that requires the data erasure operation from the first target storage area;
writing, by the storage controller, the valid data into the idle block in the first target storage area; and
erasing, by the storage controller, data in the occupied block that requires the data erasure operation from the first target storage area.

2. The method according to claim 1, further comprising:
receiving, by the storage controller, an idle indication message sent by an application server, wherein the application server runs the first target application, and the idle indication message indicates that the first target application is in the idle state.

3. The method according to claim 1, further comprising:
determining, by the storage controller, that a quantity of idle blocks in the first target storage area is less than a first threshold.

4. The method according to claim 1, further comprising:
determining that a quantity of invalid pages is greater than a second threshold in the occupied block that requires a data erasure operation.

5. The method according to claim 1, wherein the solid state drive further comprises a block unallocated to the first target storage area; and
wherein the method further comprises:
replacing, by the storage controller, a block in the first target storage area with the unallocated block according to wear leveling of the first target storage area.

6. The method according to claim 1, wherein the solid state drive further comprises a second target storage area, the second target storage area comprises an idle block and an occupied block, the second target storage area stores only data of a second target application; and
wherein the method further comprises operations of:
reading, by the storage controller, valid data from the occupied block that requires the data erasure operation from the second target storage area;
writing, by the storage controller, the valid data into the idle block in the second target storage area; and
erasing, by the storage controller, data in the occupied block that requires the data erasure operation from the second target storage area;
wherein the operations on the second target storage area do not affect the first target application.

7. A solid state drive comprising a storage controller and a storage medium, the storage medium comprises a first target storage area, the first target storage area comprises an idle block and an occupied block, the first target storage area stores only data of a first target application, and the storage controller is configured to:
determine an occupied block that requires a data erasure operation from the first target storage area when the first target application is in an idle state;
read valid data from the occupied block that requires the data erasure operation from the first target storage area;
write the valid data into the idle block in the first target storage area; and
erase data in the occupied block that requires the data erasure operation from the first target storage area.

8. The solid state drive according to claim 7, wherein the storage controller is further configured to:
receive an idle indication message sent by an application server, wherein the application server runs the first target application, and the idle indication message indicates that the first target application is in the idle state.

9. The solid state drive according to claim 7, wherein the storage controller is further configured to:
determine that a quantity of idle blocks in the first target storage area is less than a first threshold.

10. The solid state drive according to claim 7, wherein the storage controller is further configured to:
determine that a quantity of invalid pages is greater than a second threshold in the occupied block that requires a data erasure operation.

11. The solid state drive according to claim 7, wherein the storage controller is further configured to:
replace a block in the first target storage area with an unallocated block according to wear leveling of the first target storage area.

12. The solid state drive according to claim 7, wherein the solid state drive further comprises a second target storage area, the second target storage area comprises an idle block and an occupied block, the second target storage area stores only data of a second target application; and
wherein the storage controller is further configured to perform operations of:
reading valid data from the occupied block that requires the data erasure operation from the second target storage area;
writing the valid data into the idle block in the second target storage area; and
erasing data in the occupied block that requires the data erasure operation from the second target storage area;
wherein the operations on the second target storage area do not affect the first target application.

13. A non-transitory computer readable storage medium comprising instructions that when executed by a storage controller in a solid state drive, cause the storage controller to:
determine an occupied block that requires a data erasure operation from a first target storage area in the solid state drive when a first target application is in an idle state; wherein the first target storage area stores only data of the first target application;
read valid data from the occupied block that requires a data erasure operation from the first target storage area;
write the valid data into an idle block in the first target storage area; and
erase data in the occupied block that requires a data erasure operation from the first target storage area.

14. The non-transitory computer readable storage medium according to claim 13, further comprising instructions that when executed by the storage controller, cause the storage controller to:
receive an idle indication message sent by an application server, wherein the application server runs the first target application, and the idle indication message indicates that the first target application is in the idle state.

15. The non-transitory computer readable storage medium according to claim 13, further comprising instructions that when executed by the storage controller, cause the storage controller to:
determine that a quantity of idle blocks in the first target storage area is less than a first threshold.

16. The non-transitory computer readable storage medium according to claim 13, further comprising instructions that when executed by the storage controller, cause the storage controller to:
determine that a quantity of invalid pages is greater than a second threshold in the occupied block that requires a data erasure operation.

17. The non-transitory computer readable storage medium according to claim 13, further comprising instructions that when executed by the storage controller, cause the storage controller to:
replace a block in the first target storage area with an unallocated block according to wear leveling of the first target storage area.

18. The non-transitory computer readable storage medium according to claim 13, further comprising instructions that when executed by the storage controller, cause the storage controller to perform operations of:
reading valid data from the occupied block that requires the data erasure operation from the second target storage area;
writing the valid data into the idle block in the second target storage area; and
erasing data in the occupied block that requires the data erasure operation from the second target storage area;
wherein the operations on the second target storage area do not affect the first target application.
